(19) United States
(12) Patent Application Publication
(10) Pub. No.: US 2007/0191023 A1
(43) Pub. Date: Aug. 16, 2007

(54) Method and apparatus for synthesizing presence information

(75) Inventor: Edward Walter, Boerne, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/352,642

(22) Filed: Feb. 13, 2006

(51) Int. Cl. H04Q 7/20

(52) U.S. Cl. 455/456.2

(57) ABSTRACT

A method and apparatus are disclosed for synthesizing presence information. An apparatus that incorporates teachings of the present disclosure may include, for example, a presence services system (PSS) (102) can have a controller (104) that manages operations of a communications interface (110). The controller can be programmed to monitor (302-304) presence information of one or more communication devices of an end user operating in a communications system, receive (312) a request from a remote user to access the presence information, and synthesize (314) the presence information in accordance with a privacy policy that determines a degree of disclosure permitted for the remote user. Additional embodiments are disclosed.

### FIELD OF THE DISCLOSURE

The present disclosure relates generally to techniques for managing presence information, and more specifically to a method and apparatus for synthesizing presence information.

### BACKGROUND

As landline and wireless communication services become ubiquitous, monitoring the location and activities of end users becomes easier. These improvements in the art, however, can give rise to privacy and safety concerns.

A need therefore arises for a method to manage an end user's privacy and safety in a communication system.

### BRIEF DESCRIPTION OF THE DRAWINGS

FIG. 1 depicts an exemplary embodiment of a presence services system (PSS) managing presence information flow between requesting and monitored communication devices operating in a communication system;

FIG. 2 depicts an exemplary block diagram of the requesting and monitored communication devices;

FIG. 3 depicts an exemplary method operating in the PSS and the requesting and monitored communication devices; and

FIG. 4 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for synthesizing presence information.

In a first embodiment of the present disclosure, a presence services system (PSS) can have a controller that manages operations of a communications interface. The controller can be programmed to monitor presence information of one or more communication devices of an end user operating in a communications system, receive a request from a remote user to access the presence information, and synthesize the presence information in accordance with a privacy policy that determines a degree of disclosure permitted for the remote user.

In a second embodiment of the present disclosure, a computer-readable storage medium operates in a presence services system (PSS) having computer instructions for synthesizing, in response to a request, presence information associated with one or more communication devices of an end user according to a policy.

In a third embodiment of the present disclosure, a requesting communication device can have a controller that manages operations of a transceiver for exchanging messages in a communication system. The controller can be programmed to transmit to a presence services system (PSS) a request for presence information associated with a targeted end user having one or more monitored communication devices, and receive from the PSS synthesized presence information associated with the targeted end user according to an identity of the requesting communication device, and a disclosure policy operating in the PSS.

In a fourth embodiment of the present disclosure, a monitored communication device can have a controller that manages operations of a location receiver, and a transceiver for exchanging messages in a communication system. The controller can be programmed to determine a location fix of the monitored communication device, and transmit the location fix to a presence services system (PSS) for monitoring presence information of the monitored communication device and for synthesizing the presence information for requesting communication devices according to their identity, and a disclosure policy operating in the PSS.

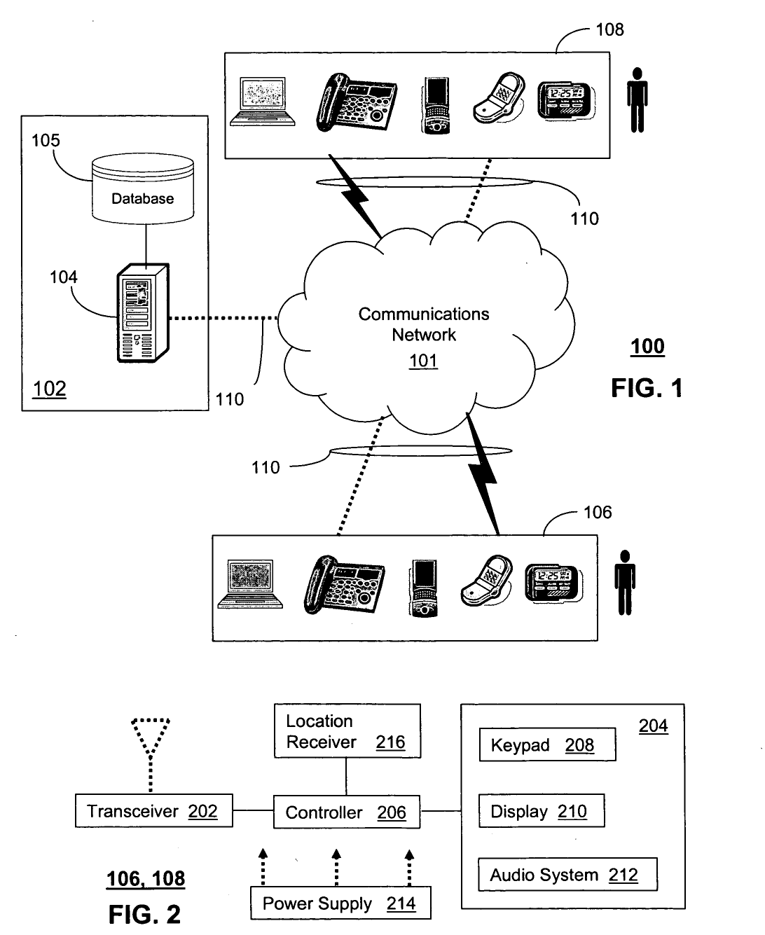

FIG. 1 depicts an exemplary embodiment of a presence services system (PSS) 102 managing presence information flow between requesting and monitored communication devices 106-108 operating in a communication system 100. The PSS 102 can comprise a communications interface 110, a memory 105 and a controller 104. The communications interface 110 can use common wired or wireless communications technology for interfacing to a communications network 101 that can support circuit switched and/or a packet switched communications.

The communications network 101 can thus offer communication devices 106-108 Internet and/or traditional voice services such as, for example, POTS (Plain Old Telephone Service), VoIP (Voice over Internet communications, IPTV (Internet Protocol Television), broadband communications, cellular telephony, as well as other known or next generation access technologies.

The controller 104 of the PSS 102 can utilize common computing technology such as a desktop computer, or scalable server. The memory 105 can include mass storage media such as a high capacity disk drive that can be used by the controller 104 to manage one or more databases for manipulating presence information according to the present disclosure.

The requesting and monitored communication devices 108 can represent any number of embodiments including, for example, a laptop or desktop computer, a telephone managed by a base unit, a personal digital assistance (PDA), a cellular phone, or paging device. Some or all of these devices can interface to the communication network 101 with a wired or wireless interface. For example, the laptop can be interconnected to the communications network 101 by a wired Ethernet port to a DSL (Digital Service Line) interface in a residence or enterprise, or by a WiFi or WiMAX wireless connection. The telephone and base unit can utilize cordless 2.4 GHz or 5.8 GHz technology for short-range roaming, and interface to the communications network using POTS or VoIP communications. The PDA and cellular phone can support common wireless access technologies for interfacing to the communications network 101.

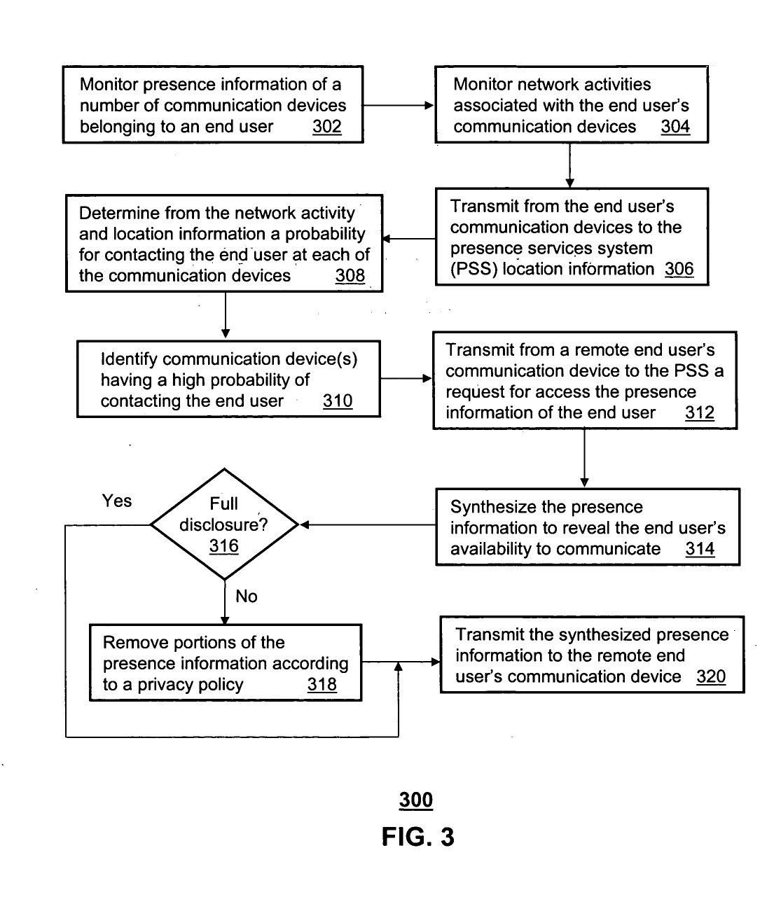

Moreover, any number of the aforementioned communication devices in FIG. 1 can be combined so as to create a multifunctional communication device. For example, VoIP, paging, email and calendaring, and cellular communication functionality can be integrated into the PDA. It should be further noted that a requesting communication device 108 can perform the functions of the monitored communication device 106, and vice-versa. Thus communication devices 106-108 can be interchangeable with respect to the monitoring and requesting steps described by the flowchart of method 300 illustrated in FIG. 3.

FIG. 2 depicts an exemplary embodiment of the requesting and monitored communication devices 106-108. Each communication device can comprise a wired and/or wireless transceiver 202, a user interface (UI) 204, a power supply 214, and a controller 206 for managing operations thereof. In an embodiment where the communication devices 106-108 operate in a landline environment, the transceiver 202 utilizes common wireline access technology to support POTS or VoIP services.

In a wireless communications setting, the transceiver 202 can utilize common technologies to support singly or in combination any number of wireless access technologies including without limitation cordless technologies, Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMAIHSDPA, GSM/GPRS, TDMA/EDGE, and EVDO. SDR can be utilized for accessing a public or private communication spectrum according to any number of communication protocols that can be dynamically downloaded over-the-air to the communication device.

It should be noted also that next generation wireless access technologies can be applied to the present disclosure.

The UI 204 can include a keypad 208 with depressible or touch sensitive navigation disk and keys for manipulating operations of the communication device. The UI 204 can further include a display 210 such as monochrome or color LCD (Liquid Crystal Display) for conveying images to the end user of the communication device, and an audio system 212 that utilizes common audio technology for conveying and intercepting audible signals of the end user.

The power supply 214 can utilize common power management technologies such as replaceable batteries, supply regulation technologies, and charging system technologies for supplying energy to the components of the communication device and to facilitate portable applications. In stationary applications, the power supply 214 can be modified so as to extract energy from a common wall outlet and thereby supply DC power to the components of the communication device.

The controller 206 can utilize computing technologies such as a microprocessor and/or digital signal processor (DSP) with associated storage memory such a Flash, ROM, RAM, SRAM, DRAM or other like technologies for controlling operations of the aforementioned components of the communication device. In a supplemental embodiment, the communication device can include a location receiver 216 such as a common GPS (Global Positioning System) receiver that can intercept satellite signals and therefrom determine a location fix of the communication device.

FIG. 3 depicts an exemplary method 300 operating in the PSS 102 and the requesting and monitored communication devices 106-108. Method 300 begins with step 302 where the controller 104 of the PSS 102 monitors presence information of a number of communications devices 106 carried by the end user. The presence information can be derived each time the communication device 106 authenticates itself with the communications network 101. The presence traffic can be in the form of XML (Extensible Markup Language), SIP (Session Initiation Protocol), or other present or next generation protocols which support the exchange of presence information. The controller 104 can also be programmed to monitor in step 304 network activities associated with the end user's communication devices 106.

In step 304, the controller 104 can monitor, for example, roaming information, and egress or ingress data traffic associated with each communication device 106. The roaming information can for instance indicate that the end user is roaming from one cellular tower to another. With common triangulation techniques, the controller 104 can be programmed to determine the whereabouts of the end user, as well as make a prediction as to which of the communication devices 106 the end user is carrying, and which may have been left at home or in the office. The ingress and egress traffic can also provide an indication of real-time and frequency of use of each of the communication devices 106. With the foregoing information the controller 104 can thus hone in on the end user's behavior, location and availability.

In step the monitored communication device 106 can be programmed to periodically transmit to the PSS 102 location information processed by the location receiver 216. The controller 104 can utilize the location information to more precisely determine the whereabouts and availability of the end user for receiving calls from remote parties.

From the information gathered in steps 302-306, the controller 104 can be programmed in step 308 to determine probabilities of contacting the end user at any one of the communication devices 106. The network activities can indicate, for example, that the end user's cellular phone is roaming; in which case the controller 104 can establish a probability that shows it is more likely the end user can be reached on his cell phone, than on his laptop or desktop computer. The probability calculations of step 308 can consist of any known or next generation statistical or analytical formulation (e.g., linear regression). From the probabilities determined in step 308, the controller 104 can be programmed to identify in step 310 a communication device having the highest probability of contacting the end user upon receiving a call from a remote party. In cases where the probability differences are high and marginally the same for multiple communication devices, step 310 can identify more than one device.

In step 312, a requesting communication device 108 can at the direction of its end user transmit a request to the PSS 102 for access to the presence information associated with the monitored communication 106. The request can include among other things an identity of the requesting end user and identity of the targeted end user. The identity of the requesting party can be a reference number associated with the requesting communication device 108, or some other form of recognizable identification that can be processed by the PSS 102.

From the information monitored in steps 302-310 and the requesting end user's identification, the controller 104 of the PSS 102 can be programmed to synthesize the presence information gathered in these steps to reveal the targeted end user's availability to communicate on one or more communication devices 106 controlled thereby. Rather than providing the requesting party the raw presence information of steps 302-310, the controller 104 can be programmed to synthesized said raw information into a coherent understanding of the end user's availability. For example, the controller 104 can synthesized presence information so as to indicate that the end user is engaged in a telephone conversation at his desk, and can be unintrusively reached by way of email or instant messaging services on his computer. The controller 104 can further indicate in the synthesized presence information that the end user is not carrying his cell phone or pager because it was not authenticated with the network (101) (e.g., the end user did not turn them on).

Depending on the requesting end user's identification, the controller 104 can be programmed in step 316 to make a full disclosure, partial or non-disclosure of the presence information of step 314 in accordance with a policy established by the end user or corporate personnel in a private or enterprise setting. The policy can be based on any rules of disclosure desirable to the end user or enterprise for the purpose of protecting the end user's privacy and/or security.

The policy can be represented, for example, by a hierarchical disclosure scheme in which each level of the hierarchy includes rules varying the degree of disclosure given to a pool of requesting parties. Parties at the top of the hierarchy can receive more information than those below. The degrees of disclosure can vary from full disclosure to intermediate disclosure to no disclosure at all. For instance, in a corporate setting an IT (Information Technology) manager can manage a policy for a CEO in which a first tier, represented by the CEO's direct staff, can request and be given by the controller 104 in step 316 full disclosure of the synthesized presence information generated in step 314, while second and higher tier requesters receive partial or no disclosure at all.

In step 318, the controller 104 can thus be programmed to vary the degrees of disclosure by selectively removing or discarding portions of the presence information prior to its transmission to a requesting party in step 320. For instance, the controller 104 can be programmed to disclose to the second tier of requesting parties that the CEO's stationary phone and computer are available to receive calls and emails with no indication given as to the whereabouts of the CEO, or the state of use of the other communication devices of the CEO. A first tier requester, on the other hand, can receive full disclosure that indicates, for example, that the CEO is at a particular airport using his laptop on a WiFi network, and can be readily reached on his cell phone or laptop. For security and privacy reasons, the IT manager can program the PSS 102 to bar disclosure of presence information to third and higher tier requesting parties.

The policy of disclosure programmed into the PSS 102 can be customized per end user, or can be structured across tiers of end users. The latter embodiment tends to be more manageable for mid to large enterprise users. For the protection and safety of end users, the disclosure policy can be dynamically varied according to the circumstances of the end user at the time a request is made. For example, disclosure rules can be varied to account for the cases in which the end user is at his office, or engaged in domestic or international travel.

From the foregoing embodiments of method 300, it would be evident to an artisan with ordinary skill in the art that it would be impractical to describe all possible modifications and enhancements for constructing a disclosure policy. Accordingly, the reader is directed to the claims below for an understanding of the scope of the present disclosure.

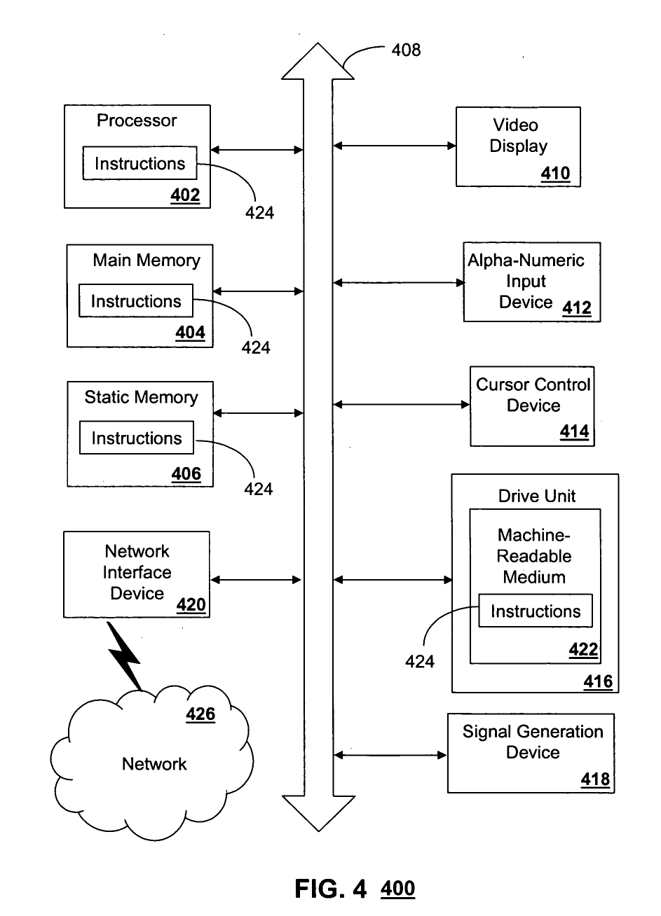

FIG. 4 depicts an exemplary diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A presence services system (PSS), comprising:
a controller that manages operations of a communications interface, wherein the controller is programmed to:
monitor presence information of one or more communication devices of an end user operating in a communications system;
receive a request from a remote user to access the presence information; and
synthesize the presence information in accordance with a privacy policy that determines a degree of disclosure permitted for the remote user.

2. The PSS of claim 1, wherein the controller is programmed to transmit the synthesized presence information to the remote user.

3. The PSS of claim 1, wherein the presence information comprises network activities monitored within the communication system for each of the communication devices, and wherein the controller is programmed to determine from the activities monitored a probability for each of the communication devices that the end user will accept an incoming call from the remote user.

4. The PSS of claim 3, wherein the network activities for each of the communication devices comprise roaming information, egress data traffic, or ingress data traffic.

5. The PSS of claim 3, wherein the controller is programmed to identify a select one of the communication devices having a highest probability that the end user will accept an incoming call from the remote user.

6. The PSS of claim 1, wherein the privacy policy comprises a hierarchical disclosure policy for each of a plurality of remote users, and wherein the controller is programmed to synthesize the presence information according to the hierarchical disclosure policy.

7. The PSS of claim 1, wherein the controller is programmed to:
receive location information from one or more of the communication devices of the end user; and
synthesize the presence information according to the location information.

8. The PSS of claim 1, wherein the controller is programmed to:
synthesize the presence information to reveal the end user's availability to communicate with the remote user; and
remove from the presence information at least one among the end user's whereabouts, and an identity of the one or more communication devices being used by the end user at the time when the request for presence information is made by the remote user.

9. The PSS of claim 1, wherein the controller is programmed to synthesize the presence information to reveal at least one among the end user's availability to communicate with the remote user, the end user's whereabouts, and an identity of the one or more communication devices being used by the end user at the time when the request for presence information is made by the remote user.

10. A computer-readable storage medium in a presence services system (PSS), comprising computer instructions for synthesizing, in response to a request, presence information associated with one or more communication devices according to a policy.

11. The storage medium of claim 10, comprising computer instructions for determining probabilities for contacting the end user at each of the communication devices according to network activities in a communication system associated therewith.

12. The storage medium of claim 1, wherein the network activities comprise roaming information, egress data traffic, or ingress data traffic.

13. The storage medium of claim 11, comprising computer instructions for identifying a select one of the communication devices having a high probability for the end user to accept an incoming call.

14. The storage medium of claim 10, wherein the policy comprises a hierarchical disclosure policy, and wherein the storage medium comprises computer instructions for synthesizing the presence information according to the hierarchical disclosure policy.

15. The storage medium of claim 10, comprising computer instructions for synthesizing the presence information according to location information supplied by one or more of the communication devices.

16. The storage medium of claim 10, wherein the policy comprises safety and privacy rules, and wherein the storage medium comprises computer instructions for removing portions of the presence information according to the safety and privacy rules.

17. The storage medium of claim 10, comprising computer instructions for masking from the presence information one among whereabouts of the end user, and which of the one or more communication devices is being used by the end user at the time when the request for presence information is made.

18. The storage medium of claim 10, comprising computer instructions for synthesizing the presence information to reveal at least one among the end user's availability to communicate, the end user's whereabouts, and an identity of the one or more communication devices being used by the end user at the time when the request for presence information is made.

19. A requesting communication device, comprising:
a controller that manages operations of a transceiver for exchanging messages in a communication system, wherein the controller is programmed to:
transmit to a presence services system (PSS) a request for presence information associated with a targeted end user having one or more monitored communication devices; and
receive from the PSS synthesized presence information associated with the targeted end user according to an identity of the requesting communication device and a disclosure policy of the PSS.

20. A monitored communication device, comprising:
a controller that manages operations of a location receiver and a transceiver for exchanging messages in a communication system, wherein the controller is programmed to:
determine a location fix of the monitored communication device; and
transmit the location fix to a presence services system (PSS) to monitor presence information of the monitored communication device and to synthesize the presence information for requesting communication devices according to their identity and a disclosure policy operating in the PSS.

21. The monitored communication device of claim 20, wherein the monitored communication device comprises at least one among a computer, a paging device, and a telephony device.
